(19) United States
(12) Patent Application Publication
(10) Pub. No.: US 2025/0335387 A1
(43) Pub. Date: Oct. 30, 2025

(54) SYSTEMS AND METHODS FOR ENABLING SINGLE-PORT AND DUAL-PORT STORAGE MEDIA IN A COMMON SLOT WITH LANE REVERSAL

(71) Applicant: Dell Products L.P., Round Rock, TX (US)

(72) Inventors: Richard J. BOYLE, Quincy, MA (US); Tobias Schaeffer, Watertown, MA (US); James GUYER, Northboro, MA (US); Thomas N. DIBB, Rutland, MA (US)

(73) Assignee: Dell Products L.P., Round Rock, TX (US)

(21) Appl. No.: 18/647,751

(22) Filed: Apr. 26, 2024

(51) Int. Cl. G06F 13/42

(52) U.S. Cl. CPC G06F 13/4204; G06F 2213/0026

(57) ABSTRACT

An information handling system may include a storage medium, a first storage interface communicatively coupled to the storage medium, and a second storage interface communicatively coupled to the storage medium. Communications lanes of a communications port of the first storage interface may be routed via standard routing to lower communications lanes of the storage medium and communications lanes of a communications port of the second storage interface may be routed via lane reversal routing to higher communications lanes of the storage medium. The storage medium may be accessible over a plurality of paths whether it is dual-ported or single-ported.

### TECHNICAL FIELD

The present disclosure relates in general to information handling systems, and more particularly to systems and methods for enabling single-port and dual-port storage media in a common slot with lane reversal.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often include storage media, also known as drives or hard drives, for storing programs and data. Traditionally, information handling system platforms are built for using either a single-port drive or a dual-port drive. In a single-port drive, all communication lanes of the drive (e.g., all of its Peripheral Component Interconnect Express (PCIe) lanes) may form a single port for communication with a single processing node in an information handling system. With a dual-port drive, the communication lanes of the drive may be split into two ports, each port coupled to a respective processing node, and the dual-port drive shared by the two processing nodes.

However, there may exist a desire to support single- and dual-ported drives within the same enclosure, with support for either type of drive in all drive slots, without impacting system reliability and while introducing minimal single points of failure.

### SUMMARY

In accordance with the teachings of the present disclosure, the disadvantages and problems associated with existing approaches to supporting single- and dual-ported drives within the same enclosure may be reduced or eliminated.

In accordance with embodiments of the present disclosure, an information handling system may include a storage medium, a first storage interface communicatively coupled to the storage medium, and a second storage interface communicatively coupled to the storage medium. Communications lanes of a communications port of the first storage interface may be routed via standard routing to lower communications lanes of the storage medium and communications lanes of a communications port of the second storage interface may be routed via lane reversal routing to higher communications lanes of the storage medium.

In accordance with embodiments of the present disclosure, a method may be provided in an information handling system comprising a storage medium, a first storage interface communicatively coupled to the storage medium, and a second storage interface communicatively coupled to the storage medium. The method may include routing communications lanes of a communications port of the first storage interface via standard routing to lower communications lanes of the storage medium and routing communications lanes of a communications port of the second storage interface via lane reversal routing to higher communications lanes of the storage medium.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates another block diagram of the example information handling system depicted in FIG. 1, in accordance with embodiments of the present disclosure;

FIG. 3 illustrates a block diagram of another example information handling system, in accordance with embodiments of the present disclosure;

FIG. 4 illustrates a block diagram of yet another example information handling system, in accordance with embodiments of the present disclosure; and

FIG. 5 illustrates a block diagram of an additional example information handling system, in accordance with embodiments of the present disclosure.

### DETAILED DESCRIPTION

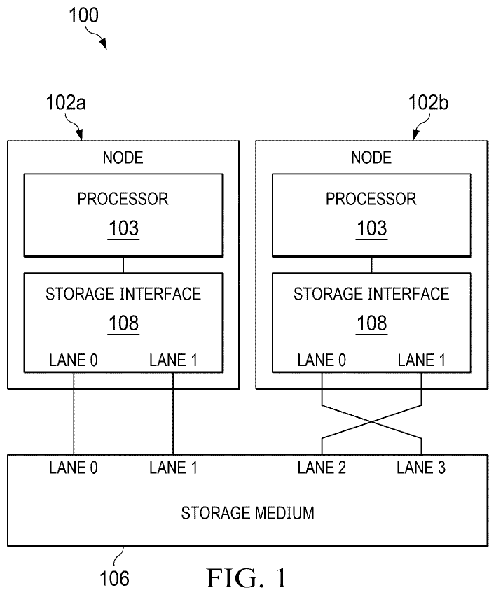

Preferred embodiments and their advantages are best understood by reference to FIGS. 1 through 5, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input and output (“I/O”) devices, such as a keyboard, a mouse, and a video display. The information handling system may also include one or more buses operable to transmit communication between the various hardware components.

For the purposes of this disclosure, information handling resources may broadly refer to any component system, device or apparatus of an information handling system, including without limitation processors, buses, memories, input-output devices and/or interfaces, storage resources, network interfaces, motherboards, electro-mechanical devices (e.g., fans), displays, and power supplies.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (“RAM”), read-only memory (“ROM”), electrically erasable programmable read-only memory (“EEPROM”), and/or flash memory; as well as communications media such as wires, optical fibers, microwaves, radio waves, and other electromagnetic and/or optical carriers; and/or any combination of the foregoing.

Information handling systems often use an array of physical storage resources (e.g., disk drives), such as a Redundant Array of Independent Disks (“RAID”), for example, for storing information. Arrays of physical storage resources typically utilize multiple disks to perform input and output operations and can be structured to provide redundancy which may increase fault tolerance. Other advantages of arrays of physical storage resources may be increased data integrity, throughput and/or capacity. In operation, one or more physical storage resources disposed in an array of physical storage resources may appear to an operating system as a single logical storage unit or “logical unit.” Implementations of physical storage resource arrays can range from a few physical storage resources disposed in a chassis, to hundreds of physical storage resources disposed in one or more separate storage enclosures.

FIG. 1 illustrates a block diagram of an example information handling system 100, in accordance with embodiments of the present disclosure. In some embodiments, information handling system 100 may comprise a server. In these and other embodiments, information handling system 100 may comprise a personal computer. In other embodiments, information handling system 100 may be a portable computing device (e.g., a laptop, notebook, tablet, handheld, smart phone, personal digital assistant, etc.). As depicted in FIG. 1, information handling system 100 may include a plurality of processing nodes 102a, 102b, and a storage medium 106 coupled to each of nodes 102a, 102b.

Each of nodes 102a and 102b may be understood to represent separate information handling systems. For example, nodes 102a and 102b may represent stand-alone information handling systems that share access to storage medium 106, represent server blades or sleds within a chassis system that share the access to the storage medium 106, or may represent other types of systems that share access to storage medium 106, as needed or desired.

Each node 102 may include a processor 103 and a storage interface 108 communicatively coupled to processor 103. Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in a memory or other computer-readable medium of information handling system 102.

Storage interface 108 may comprise any suitable electrical and/or electronic interface configured to interface between processor 103 and storage medium 106, and may include, without limitation, a management controller (e. g., baseboard management controller, remote access chassis management controller, enclosure controller, controller), complex programmable logic device, other programmable logic device, and/or a combination thereof. As shown in FIG. 1 each storage interface 108 may include a port (e.g., a PCIe port) having a plurality of communication lanes (e.g., LANE 0 and LANE 1).

In addition to processor 103 and storage interface 108, a node 102 may include one or more other information handling resources.

Storage medium 106 may include a hard disk drive, magnetic tape library, optical disk drive, magneto-optical disk drive, compact disk drive, compact disk array, disk array controller, Non-Volatile Memory Express (NMVe) storage resource, and/or any other system, apparatus or device operable to store media.

In addition to nodes 102 and storage medium 106, information handling system 100 may include one or more other information handling resources and/or information handling systems.

As shown in FIG. 1, routing between communication lanes (e.g., LANE 0 and LANE 1) of the port of node 102a and the lower lanes (e.g. LANE 0 and LANE 1) of storage medium 106 may be “standard routing,” in which LANE 0 of the port of node 102a and LANE 0 of storage medium 106 are communicatively coupled to one another and in which LANE 1 of the port of node 102a and LANE 1 of storage medium 106 are communicatively coupled to one another. However, as also shown in FIG. 1, routing between communication lanes (e.g., LANE 0 and LANE 1) of the port of node 102b and the upper lanes (e.g. LANE 2 and LANE 3) of storage medium 106 may be reversed, in which LANE 0 of the port of node 102b and LANE 3 of storage medium 106 are communicatively coupled to one another and in which LANE 1 of the port of node 102b and LANE 2 of storage medium 106 are communicatively coupled to one another.

Speaking more generally, in a storage medium having N communication lanes, a first processing node (e.g., processing node 102a) may have its first lane (e.g., LANE 0) mapped to the first lane of the storage medium, its second lane (e.g., LANE 1) mapped to the second lane of the storage medium, and so on, while a second processing node (e.g., processing node 102b) may have its first lane (e.g., LANE 0) mapped to the Nth lane of the storage medium, its second lane (e.g., LANE 1) mapped to the N-1 lane of the storage medium, and so on.

By enforcing standard routing from one processing node to the lower lanes of a storage medium and reversed routing from a peer processing node to the upper lanes of the storage medium, orderly training of the links may be assured in all cases.

Using such routing, nodes 102 and storage medium 106 may take on one of three configurations. The first configuration may be a single-port mode in which node 102a is active and performs link training in a standard lane configuration, with the link between node 102b and storage medium 106 held down. The second configuration may be a single-port mode in which node 102b is active and performs link training in a reversed lane configuration, with the link between node 102a and storage medium 106 held down. A third configuration may be a dual-port mode in which both nodes 102a and 102b are active, wherein a first port of storage medium 106 trains in a standard configuration with node 102a and a second port of storage medium 106 trains in a reversed lane configuration with node 102b.

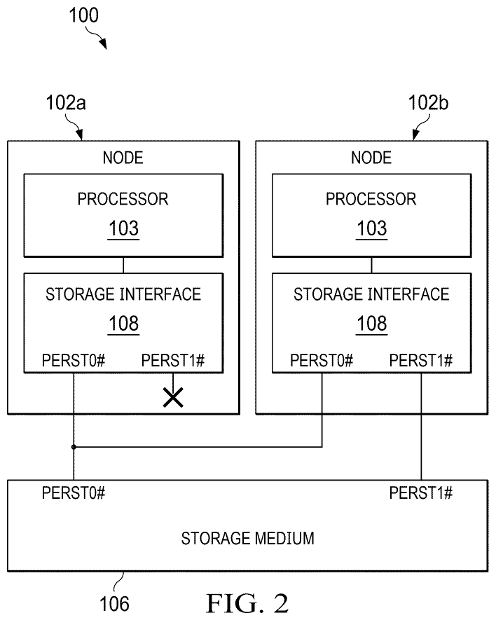

FIG. 2 illustrates another block diagram of the example information handling system 100, in accordance with embodiments of the present disclosure. In particular, FIG. 2 depicts coupling of port reset input (PERST) signals of nodes 102 and storage medium 106. As shown in FIG. 2, the lower-indexed PERST pin (e.g., PERST0#) of each node 102 may be coupled to the lower-indexed PERST pin (e.g., PERST0#) of storage medium 106. Accordingly, in a single-port configuration, whichever of nodes 102 is the active node may own the pin state of the lower-indexed PERST pin of storage medium 106.

As also shown in FIG. 2, the higher-indexed PERST pin (e.g., PERST1#) of node 102b may be coupled to the higher-indexed PERST pin (e.g., PERST1#) of storage medium 106. Thus, in the dual-port configuration, node 102a may own the pin state of the lower-indexed PERST pin while node 102b may own the pin state of the higher-indexed PERST pin of storage medium 106.

Advantageously, the approach described above may not, as compared to existing approaches, require the addition of active components, paddle cards, a population matrix, and/or other resources.

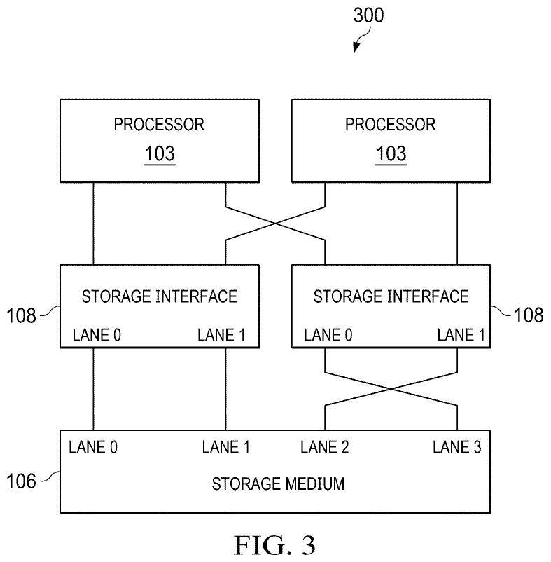

Among the advantages of the systems and methods described herein, and in particular the communicative coupling among storage interfaces and a storage medium described above, are that they may enable high availability of a storage medium to processors. For example, FIGS. 3, 4, and 5 depict other example information handling systems for which the communicative coupling among storage interfaces 108 and storage medium 106 may enable high availability of storage medium 106 to processors 103.

FIG. 3 illustrates a block diagram of an example information handling system 300, in accordance with embodiments of the present disclosure. Information handling system 300 depicted in FIG. 3 may be similar in many respects to information handling system 100 depicted in FIG. 1, and thus only particular differences between information handling system 100 and information handling system 300 may be described below.

One difference between information handling system 100 and information handling system 300 is that in information handling system 300, each processor 103 may be coupled to each storage interface 108, thus essentially providing a redundant communication path between each processor 103 and storage medium 106, which may enable high availability of storage medium 106 to both processors 103, such as when a particular storage interface 108 may fail or otherwise become unavailable.

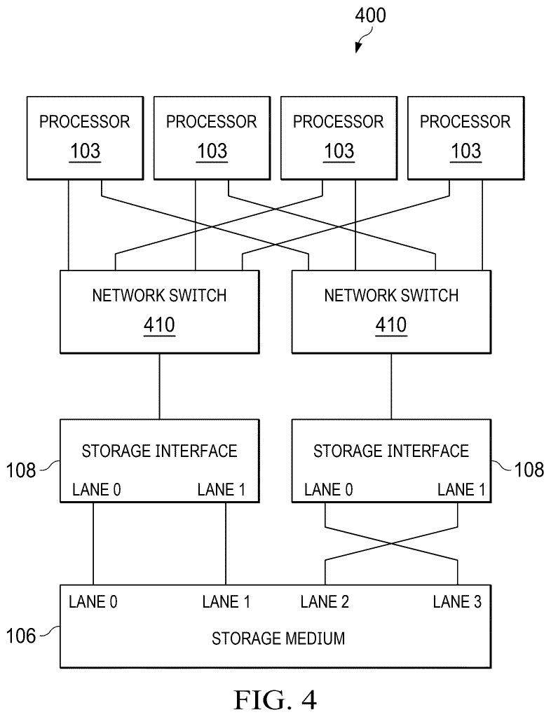

FIG. 4 illustrates a block diagram of an example information handling system 400, in accordance with embodiments of the present disclosure. Information handling system 400 depicted in FIG. 4 may be similar in many respects to information handling system 100 depicted in FIG. 1, and thus only particular differences between information handling system 100 and information handling system 400 may be described below.

One difference between information handling system 100 and information handling system 400 is that in information handling system 400, a plurality of network switches 410 may be communicatively interfaced between each storage interface 108 and a plurality of processors 103. Accordingly, each processor 103 may have a first path to storage medium 106 via a first network switch 410 and first storage interface 108 and a second path to storage medium 106 via a second network switch 410 and second storage interface 108. Accordingly, the systems and methods depicted in FIG. 4 may provide a redundant communication path between each processor 103 and storage medium 106, which may enable high availability of storage medium 106 to both processors 103, such as when a particular storage interface 108 and/or network switch 410 may fail or otherwise become unavailable.

Although FIG. 4 depicts four processors 103 present within information handling system 400 for the purposes of clarity and exposition, it is understood that information handling system 400 may have any suitable number of processors 103 coupled to network switches 410.

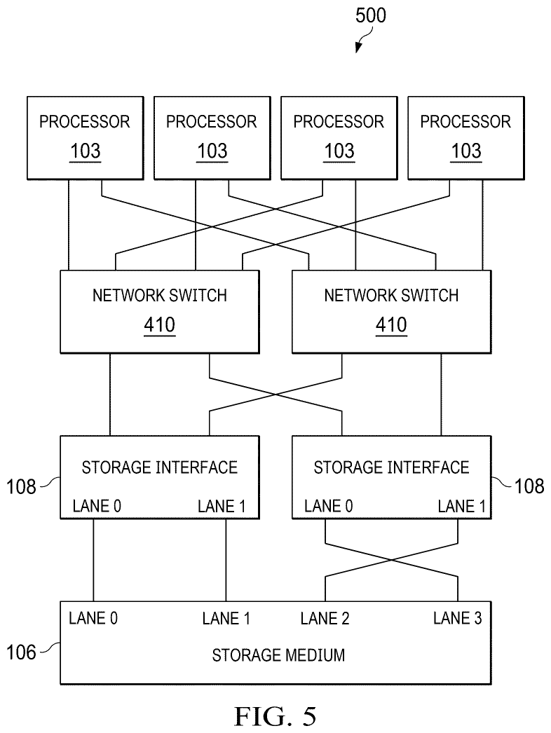

FIG. 5 illustrates a block diagram of an example information handling system 500, in accordance with embodiments of the present disclosure. Information handling system 500 depicted in FIG. 5 may be similar in many respects to information handling system 400 depicted in FIG. 4, and thus only particular differences between information handling system 400 and information handling system 500 may be described below.

One difference between information handling system 400 and information handling system 500 is that in information handling system 500, each network switch 410 may be coupled to each storage interface 108, thus essentially providing a redundant communication path between each network switch 410 and storage medium 106, providing even higher availability of storage medium 106 to processors 103 than information handling system 400.

Although FIG. 5 depicts four processors 103 present within information handling system 500 for the purposes of clarity and exposition, it is understood that information handling system 500 may have any suitable number of processors 103 coupled to network switches 410.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a storage medium;
a first storage interface communicatively coupled to the storage medium; and
a second storage interface communicatively coupled to the storage medium;
wherein:
communications lanes of a communications port of the first storage interface are routed via standard routing to lower communications lanes of the storage medium; and
communications lanes of a communications port of the second storage interface are routed via lane reversal routing to higher communications lanes of the storage medium.

2. The information handling system of claim 1, wherein the information handling system is configured to operate in a single-port mode in which the first storage interface is active, the second storage interface is inactive, and the storage medium performs training with the first storage interface in a standard lane configuration.

3. The information handling system of claim 2, wherein a lowest-indexed port reset pin of the first storage interface and a lowest-indexed port reset pin of the second storage interface is coupled to a lowest-indexed port reset pin of the storage medium, and the first storage interface owns the pin state of the lowest-indexed port reset pin of the storage medium.

4. The information handling system of claim 1, wherein the information handling system is configured to operate in a single-port mode in which the second storage interface is active, the first storage interface is inactive, and the storage medium performs training with the storage interface in a reversed lane configuration.

5. The information handling system of claim 4, wherein a lowest-indexed port reset pin of the first storage interface and a lowest-indexed port reset pin of the second storage interface is coupled to a lowest-indexed port reset pin of the storage medium, and the second storage interface owns the pin state of the lowest-indexed port reset pin of the storage medium.

6. The information handling system of claim 1, wherein the information handling system is configured to operate in a dual-port mode in which the first storage interface is active, the second storage interface is active, and a first port of the storage medium performs training with the first storage interface in a standard lane configuration and a second port of the storage medium performs training with the second storage interface in a reversed lane configuration.

7. The information handling system of claim 6, wherein a lowest-indexed port reset pin of the first storage interface is coupled to a lowest-indexed port reset pin of the storage medium, a highest-indexed port reset pin of the second storage interface is coupled to a highest-indexed port reset pin of the storage medium, the first storage interface owns the pin state of the lowest-indexed port reset pin of the storage medium, and the second storage interface owns the pin state of the highest-indexed port reset pin of the storage medium.

8. A method comprising, in an information handling system comprising a storage medium, a first storage interface communicatively coupled to the storage medium, and a second storage interface communicatively coupled to the storage medium:
routing communications lanes of a communications port of the first storage interface via standard routing to lower communications lanes of the storage medium; and
routing communications lanes of a communications port of the second storage interface via lane reversal routing to higher communications lanes of the storage medium.

9. The method of claim 8, further comprising operating the information handling system in a single-port mode in which the first storage interface is active, the second storage interface is inactive, and the storage medium performs training with the first storage interface in a standard lane configuration.

10. The method of claim 9, further comprising coupling a lowest-indexed port reset pin of the first storage interface and a lowest-indexed port reset pin of the second storage interface to a lowest-indexed port reset pin of the storage medium such that the first storage interface owns the pin state of the lowest-indexed port reset pin of the storage medium.

11. The method of claim 8, further comprising operating the information handling system in a single-port mode in which the second storage interface is active, the first storage interface is inactive, and the storage medium performs training with the second storage interface in a reversed lane configuration.

12. The method of claim 11, further comprising coupling a lowest-indexed port reset pin of the first storage interface and a lowest-indexed port reset pin of the second storage interface to a lowest-indexed port reset pin of the storage medium such that the second storage interface owns the pin state of the lowest-indexed port reset pin of the storage medium.

13. The method of claim 8, further comprising operating the information handling system in a dual-port mode in which the first storage interface is active, the second storage interface is active, and a first port of the storage medium performs training with the first storage interface in a standard lane configuration and a second port of the storage medium performs training with the second storage interface in a reversed lane configuration.

14. The method of claim 13, further comprising:
coupling a lowest-indexed port reset pin of the first storage interface to a lowest-indexed port reset pin of the storage medium such that the first storage interface owns the pin state of the lowest-indexed port reset pin of the storage medium; and
coupling a highest-indexed port reset pin of the second storage interface to a highest-indexed port reset pin of the storage medium such that the second storage interface owns the pin state of the highest-indexed port reset pin of the storage medium.
